(19) United States
(12) Patent Application Publication
(10) Pub. No.: US 2026/0321152 A1
(43) Pub. Date: Oct. 15, 2026

(54) AUTOMATIC INTERACTION DATA COLLECTION AND ANALYSIS IN AUGMENTATIVE AND ALTERNATIVE COMMUNICATION DEVICE TRAINING USING A WEARABLE DEVICE

(71) Applicant: University of New Hampshire, Durham, NH (US)

(72) Inventors: Diliang CHEN, Newmarket, NH (US); Szu-Han Kay CHEN, Stratham, NH (US)

(21) Appl. No.: 19/642,161

(22) Filed: Apr. 8, 2026

Related U.S. Application Data
(60) Provisional application No. 63/786,545, filed on Apr. 10, 2025.

(51) Int. Cl. G09B 5/00; G06F 3/01; G09B 21/00; G10L 17/26; G10L 25/51

(52) U.S. Cl. CPC G09B 5/00; G06F 3/014; G06F 3/017; G10L 17/26; G10L 25/51; G06F 2203/0331; G09B 21/00

(57) ABSTRACT

In one aspect, systems and methods for evaluating training of an augmented and alternative communication (AAC) speaker by differentiating between AAC speaker touch events and other touch events to an AAC device include providing, to any person other than the AAC speaker who will touch the AAC device during the training session, a wearable device configured to sense hand or finger movements. The systems and methods may include capturing, during the training session, audio data including AAC device-generated vocalizations, and analyzing gesture data from each wearable device in view of the audio data to identify correspondence between a respective motion signal set and a begin time of an AAC device-generated vocalization. AAC device-generated vocalizations having no corresponding wearable device touch event may be correlated with AAC speaker inputs.

### CROSS-REFERENCE TO RELATED APPLICATIONS

This application claims priority to U.S. Provisional Application No. 63/786,545 filed on Apr. 10, 2025, which is hereby incorporated herein by reference in its entirety for all purposes.

### BACKGROUND

In the United States, over five million people, including more than 450,000 children, have limited or no verbal language/speech capacity. Augmented and alternative communication (AAC) systems assist these individuals in communicating. To evaluate an individual's language performance during a training session with an AAC, AAC device manufacturers use approaches that largely depend on manual data collection and separation, which is not only time-consuming but also produces limited data. Further, present systems that have taken steps toward automation rely heavily on end users (e.g., the training communication partner working with the AAC speaker) consistently remembering to activate modes and/or use specialized training inputs to enable semi-automated data collection. The training mode activations and training inputs have proven to be awkward to use in the field, thus leading to spotty and haphazard data collection rather than capturing a rich data set. Conversely, to accurately evaluate an individual's language performance during AAC training and thereby optimize intervention strategies, a large amount of training data would be needed. The inventors recognized that new methods and systems are needed to generate full training data sets in an easy to use manner. Further, the inventors recognized that new methods and systems that are not reliant on integration with a particular manufacturer could lead to a wider training data analysis involving comparisons of usability between different AAC devices.

### SUMMARY OF ILLUSTRATIVE EMBODIMENTS

In one aspect, the present disclosure relates to a system including at least one wearable gesture data collection device and a mobile computing device executing a program (e.g., software application) configured to capture audio data of vocalizations as well as gesture data from the at least one wearable gesture data collection device and analyze the gesture data in view of the vocalizations to match gestures corresponding to a particular wearable device with AAC device vocalizations. The wearable device may be a hand and/or wrist-mounted device, such as a finger ring, designed to capture motion data indicative of a touch input to an AAC device. The wearable device may wirelessly transmit the motion data for receipt by the mobile device. The transmitted motion data may include a unique identifier associated with the wearable device, such that two or more wearable devices may be used during a training session. In illustration, a first communication partner (e.g., a paraprofessional or other individual responsible for training the AAC speaker) may don a first wearable device, and a second communication partner (e.g., a family member or other caregiver of the AAC speaker receiving the training along with the AAC speaker) may don a second wearable device. The mobile computing device may capture ambient audio of vocalizations including vocalizations of humans in the vicinity (e.g., the communication partners) as well as vocalizations produced through an audio output element (e.g., speaker) of the AAC device. The mobile computing device may filter the vocalizations to recognize audio output of the AAC device and align the AAC device audio output with timings of the motion data transmitted by the wearable device(s) to identify AAC inputs corresponding to the AAC speaker (e.g., vocalizations by the AAC device that do not align with touch gestures of a communication partner).

In one aspect, the present disclosure relates to methods for gathering audio data of vocalizations as well as gesture data from the at least one wearable gesture data collection device and analyzing the gesture data in view of the vocalizations to match gestures corresponding to a particular wearable device with AAC device vocalizations.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1 is a diagram of an example system for capturing and analyzing interactions with an Augmentative and Alternative Communication (AAC) device;

FIG. 2A and FIG. 2B illustrate a flow chart of an example method for capturing and analyzing vocalizations and gestures associated with an AAC device training session; and

FIG. 3A through FIG. 3D are graphical examples of data used in vocalization and gesture data analysis stages.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

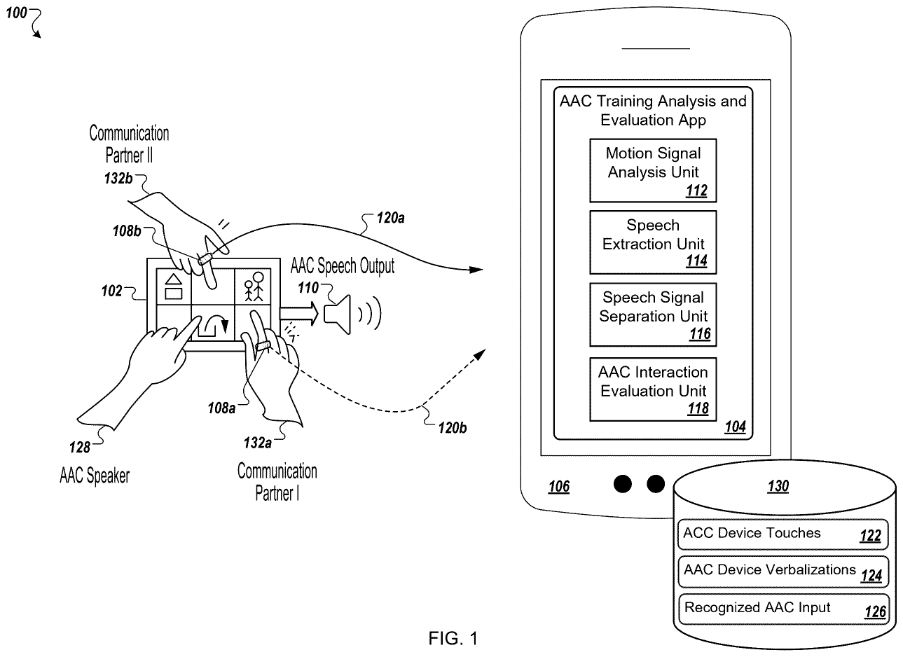

FIG. 1 is a diagram of an example system 100 for capturing and analyzing interactions with an Augmentative and Alternative Communication (AAC) device 102 using an AAC training and analysis evaluation application 104 installed on a mobile computing device 106. During interactions, a user (e.g., an AAC speaker 128 and/or a communication partner 132a, 132b) presses on graphics presented on a touch screen of the AAC device 102, each of the graphics corresponding to a speech output (e.g., word or phrase). Upon selecting (touching) one of the graphics, the AAC device 102 outputs an audio signal of the corresponding speech output. The mobile computing device 106 may be configured to capture ambient audio data, including AAC speech output 110 emitted by an audio output element (e.g., speaker) of the AAC device 102, via an audio input element (e.g., microphone) of the mobile computing device 106. The mobile computing device 106 (e.g., smart phone, tablet computer, notebook computer, etc.) may be further configured to receive gesture-related data via wireless communication from a set of wearable devices 108a, 108b worn by communication partners 132a,132b. The AAC training and analysis evaluation application 104 executing on the mobile computing device 106 may be configured to analyze the ambient audio data in relation to the gesture-related data to recognize vocalizations emitted by the AAC device 102 in response to touch inputs performed by the AAC speaker 128 being trained to use the AAC device 102.

In some implementations, each wearable device 108a, 108b includes at least one motion sensor configured to detect motions of a finger and/or hand of the wearer indicative of a touch entry to the AAC device 102. The motion sensor(s), in some examples, can include one or more acceleration detecting sensors (e.g., accelerometers), angular velocity detecting sensors (e.g., gyrometers, gyroscopes, etc.), and/or multi-axis movement sensors (e.g., inertial measurement units (IMUs)) configured to detect small motions such as a press motion of a user interacting with a touch screen interface. The number and type of motion sensor(s) used, in some examples, may be based in part on power requirements (e.g., battery draw), size, and/or unit costs. Further, the number and type of motion sensor(s) may be selected in part to refine the confidence of the measurement analysis (e.g., touch versus another hand motion). Each of the wearable devices 108a, 108b may include a short-term memory to buffer motion signals produced by the motion sensor(s) and/or processing circuitry to conduct an initial analysis of the motion signals. For example, the wearable devices 108a, 108b may be configured to initially analyze the motion signals to filter out (e.g., discard) large motions (e.g., “hand-waving” gesticulations made when communicating, picking up objects, taking notes, etc.), focusing on smaller up-down vibrational motions indicative of a screen press. Further, the wearable devices 108a, 108b may be configured to append metadata to the motion signals, such as an identifier of the particular wearable device 108a or 108b and/or a timestamp. The identifier, in an illustrative example, may be a machine access control (MAC) address of the respective wearable device 108a or 108b.

Each wearable device 108a, 108b, in some implementations, includes wireless communication circuitry configured to share motion signals with the mobile computing device 106. The motion signals, as illustrated, may be shared as a gesture data transmission 120a from the wearable device 108a and a gesture data transmission 120b from the wearable device 108b. The wireless communication circuitry, in some examples, may include Bluetooth® communication circuitry, Wi-Fi Direct communication circuitry, and/or near-field communication (NFC) circuitry. The wireless communication circuitry may allow for bi-directional (e.g., peer-to-peer) communications between the wearable device 108a, 108b and the mobile computing device 106 and/or unidirectional (e.g., broadcast) communications that may be recognized and intercepted by the mobile computing device 106.

In some implementations, wireless communication circuitry of the mobile computing device 106 (e.g., Bluetooth® communication circuitry, Wi-Fi Direct communication circuitry, and/or near-field communication (NFC) circuitry) is configured to receive gesture data from each wearable device 108a, 108b including at least a portion of the motion signals detected by the motion sensor(s) of each wearable device 108a, 108b. Further, the gesture data may include an identifier (e.g., in metadata, a communication packet header, etc.) corresponding to the particular transmitting wearable device 108a, 108b and/or a timestamp indicating a time of capture of the motion signals. The AAC training and analysis evaluation application 104 may obtain the gesture data captured via the wireless communication circuitry of the mobile computing device 106.

In some implementations, the AAC training and analysis evaluation application 104 includes a motion signal analysis unit 112 configured to analyze the motion signals captured in the gesture data transmitted by one of the wearable devices 108a, 108b to recognize a hand motion that may correspond to a press upon the touch screen of the AAC device 102c The analysis may be performed in real-time or near real-time (e.g., as transmissions such as transmissions 120a, 120b are received by the mobile computing device 106) and/or in a batch manner (e.g., after collecting a set of motion data including multiple transmissions of motion signals from the wearable devices 108a, 108b). The motion signal analysis unit 112, for example, may apply one or more filters to the motion signals received in one of the transmissions 120a, 120b to filter motion data not similar to press motions. The filter(s), in some illustrative examples, may collect and/or discard motion signals as potential touch events based on one or more of a duration of motion, a magnitude of motion, and/or a relative share of motion within a same vector of movement (e.g., up-down versus looping around). The motion signal analysis unit 112 may store instances of potential touches, with corresponding timestamps, in a storage region 130 of the mobile computing device 106 for analysis by an AAC interaction evaluation unit 118 as AAC device touches 122.

The AAC training analysis and evaluation application 104, in some implementations, includes a speech extraction unit 114 configured to extract speech audio from the ambient audio data captured by the mobile computing device 106 (e.g., via one or more microphones). The speech extraction unit 114, for example, may apply voice recognition processing to separate spoken word from other background noises within area in which the AAC speaker 128 is being trained. The speech extraction unit 114, in some embodiments, is a speech recognition functionality available through the mobile computing device 106, separate from the AAC training analysis and evaluation application 104. For example, the operations of the speech extraction unit 114 may be performed by a natural language processing system used, in illustration, for a personal assistant functionality of the mobile computing device 106. The speech extraction unit 114, in other embodiments, may apply one or more filters to separate speech audio bandwidth from other audio bandwidth.

In some implementations, the ambient audio and/or the extracted speech audio may be used by a speech signal separation unit 116 to separate AAC device speech output by a speaker of the AAC device 102 from other communication partner's speech. The speech signal separation unit 116, for example, may isolate AAC device speech output using a speech analysis functionality designed to differentiate the machine “voice” from a human voice. The speech signal separation unit 116, for example, may store instances of AAC device speech output 124, with corresponding timestamps, for analysis by the AAC interaction evaluation unit 118.

The AAC interaction evaluation unit 118, in some implementations, aligns the instances of potential touches (e.g., the ACC device touches 122) with the instances of AAC device speech (e.g., the AAC device speech output 124) to recognize AAC device vocalizations that do not correspond to touch events by either the first communication partner 132a wearing the first wearable device 108a or the second communication partner 132b wearing the second wearable device 108b. For example, the AAC device 102 may output a vocalization within a set period of time after a touch event. If no touch event is detected within the “critical time” window prior to the vocalization produced by the AAC device 102, the touch event may be assumed to have originated from the AAC speaker 128. The recognized AAC device speech may be identified as corresponding, by default, to touch interactions of the AAC speaker 128. The AAC interaction evaluation unit 118 may store the recognized AAC device speech and/or timings thereof to a recognized AAC input data set 126. The recognized AAC input 126, further, may include corresponding timestamps. The recognized AAC input 126 may be applied in later analysis of the training session. In some examples, the timing, speed, and/or content selected by the AAC speaker 128 may be evaluated and training metrics produced.

In certain embodiments, the recognized AAC input 126 includes touch interactions by each communication partner 132a, 132b in addition to the touch interactions determined to correspond to the AAC speaker 128. The touch interactions of the respective communication partners 132a, 132b, for example, may be useful in analyzing behaviors of trainers and/or family members during training sessions.

The AAC training and analysis evaluation application 104, as illustrated, includes the set of processing units 112, 114, 116, and 118 (e.g., software engines, routines, algorithms, or other portions of the AAC training analysis and evaluation application 104). Each processing unit 112, 114, 116, and/or 118 may be individually coded as instructions (e.g., software code) for executing on processing circuitry, such as one or more processors. In other embodiments, the AAC training and analysis evaluation application 104 may include more or fewer processing units. Additionally, in other embodiments, one or more processing units, or portions thereof, may be executed on a separate system, such as a cloud-based processing system or edge server.

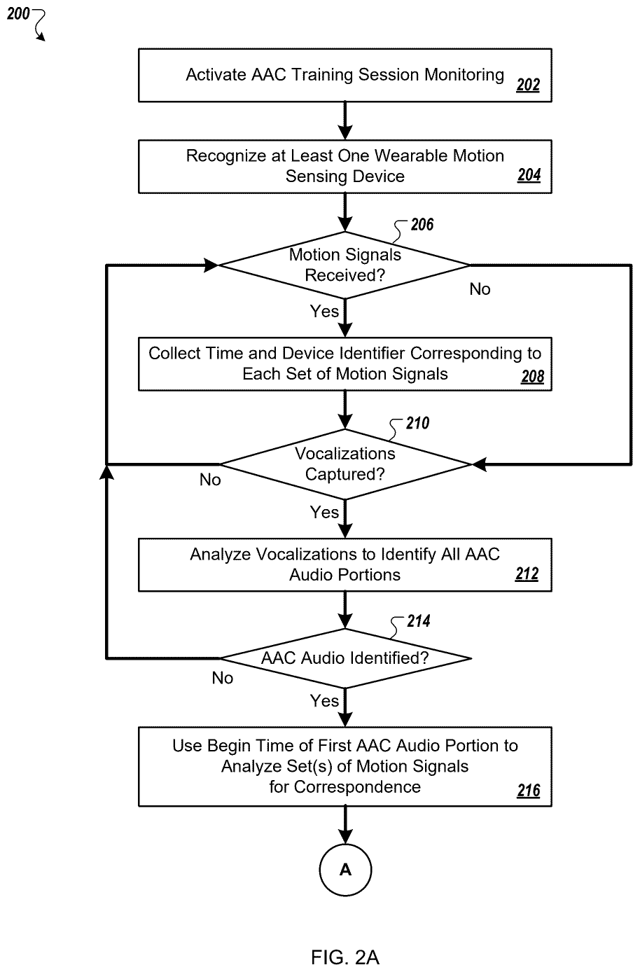

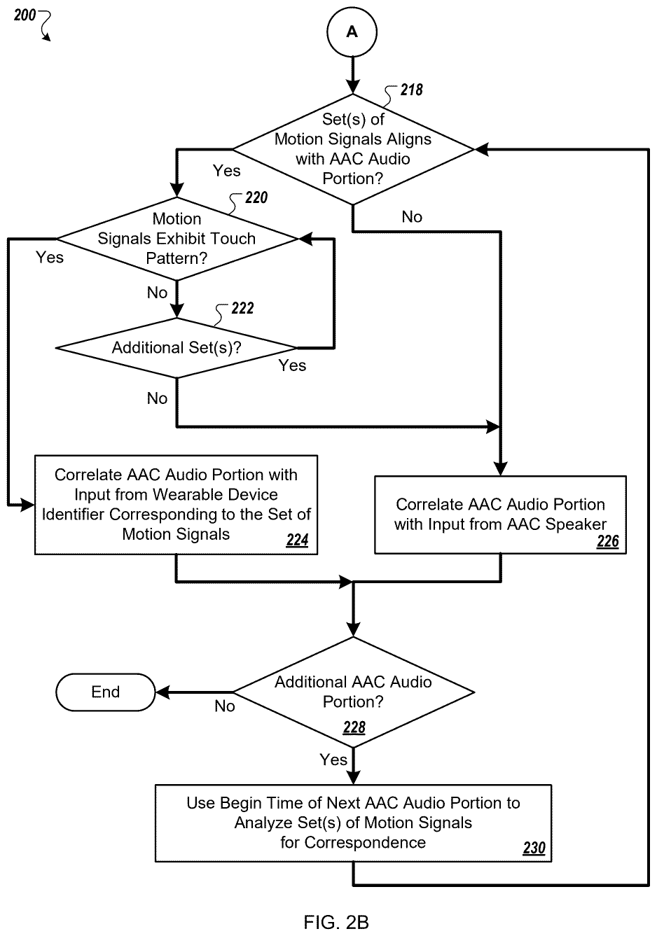

FIG. 2A and FIG. 2B illustrate a flow chart of an example method 200 for capturing and analyzing vocalizations and gestures associated with an AAC device training session. Portions of the method 200, for example, may be performed by the AAC training analysis and evaluation application 104 of FIG. 1. The method 200, for example, may be used with the wearable devices 108a, 108b of FIG. 1 to analyze a training session on the AAC device 102 of FIG. 1.

Turning to FIG. 2A, in some implementations, the method 200 begins with activating AAC training session monitoring (202). In activating the AAC training session monitoring, for example, an evaluation application may be launched, such as the AAC training analysis and evaluation application 104 of FIG. 1. A user, such as the trainer, may log into the evaluation application. The evaluation application may capture basic data regarding the training session such as, in some examples, details regarding the AAC device used in the training session, details regarding the AAC speaker being trained, and/or details regarding the wearable devices in use. In some examples, the trainer may enter an age, gender, grade level, medical diagnos(es), proficiency level and/or length of time the AAC speaker has used any form of AAC device, proficiency level and/or length of time the AAC speaker has used the particular device, geographic location of the AAC speaker and/or individually identifying information regarding the AAC speaker (e.g., name, birth date, etc.). Regarding the AAC device, the evaluation application may capture a manufacturer, a model, a serial number, an operational mode (e.g., selected layout of graphics on the screens of the AAC device), and/or a language (e.g., English, Spanish, etc.). In relation to the wearable devices, the evaluation application may individually recognize wearable devices (e.g., by serial activation of each wearable device) and accept identification of the wearer (e.g., a role such as trainer, family member, etc. and/or individual details regarding each wearer).

In some implementations, at least one wearable motion sensing device is recognized (204). The wearable motion sensing device may be one of the wearable devices 108a, 108b of FIG. 1. The device may be recognized through a handshaking mechanism with the AAC training analysis and evaluation application 104 of FIG. 1, for example. In another example, the at least one wearable motion sensing device may be recognized via a transmission of gesture data issued by the wearable device. Post-recognition (e.g., handshaking or other receipt of a transmission containing an identifier of a wearable motion sensing device), for example, the identifier of the motion sensing device may be logged for monitoring. Although illustrated as two wearable devices 108a, 108b in FIG. 1, any number of motion sensing devices may be recognized as being involved in the training session.

In some implementations, if motion signals are received (206), a time and device identifier corresponding to each set of motion signals is collected (208). For example, during and/or after a training session, motion signals may be received by the AAC training analysis and evaluation application 104 of FIG. 1. The motion signals may be transmitted as collected (e.g., in real-time or near real-time) or in a batch (e.g., periodic) transmission. The motion signals may be received from any of the motion sensing devices recognized by the method 200. The time and device identifier, for example, may be stored as part of the ACC device touches data set 122 of FIG. 1. The time may be included in the transmission or logged upon receipt of the transmission (e.g., time of receipt, duration based on contents of motion signals themselves, etc.). The motion signal analysis unit 112 of FIG. 1, for example, may receive the motion signals and, if not already included, determine the timestamp of each. The receipt (206) and collection (208) may continue in an ongoing fashion during a training session.

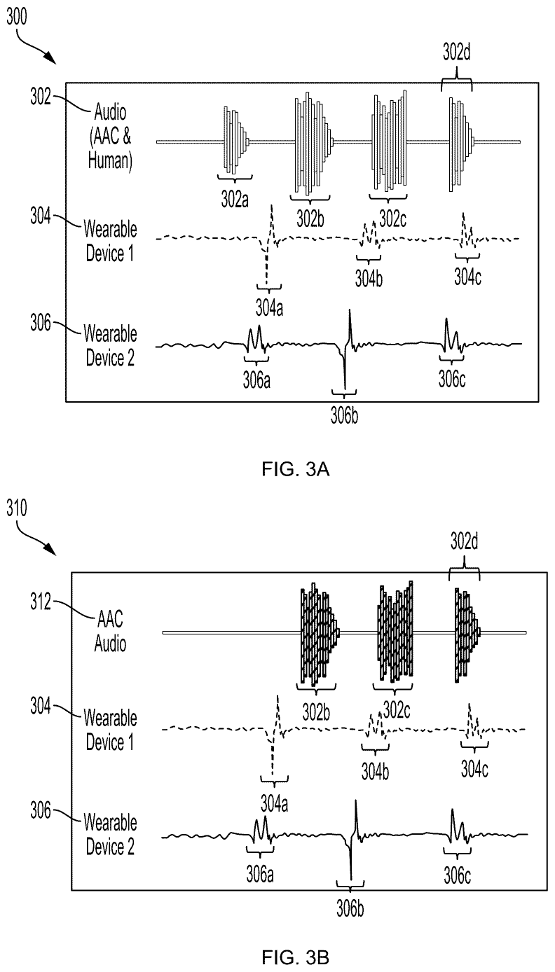

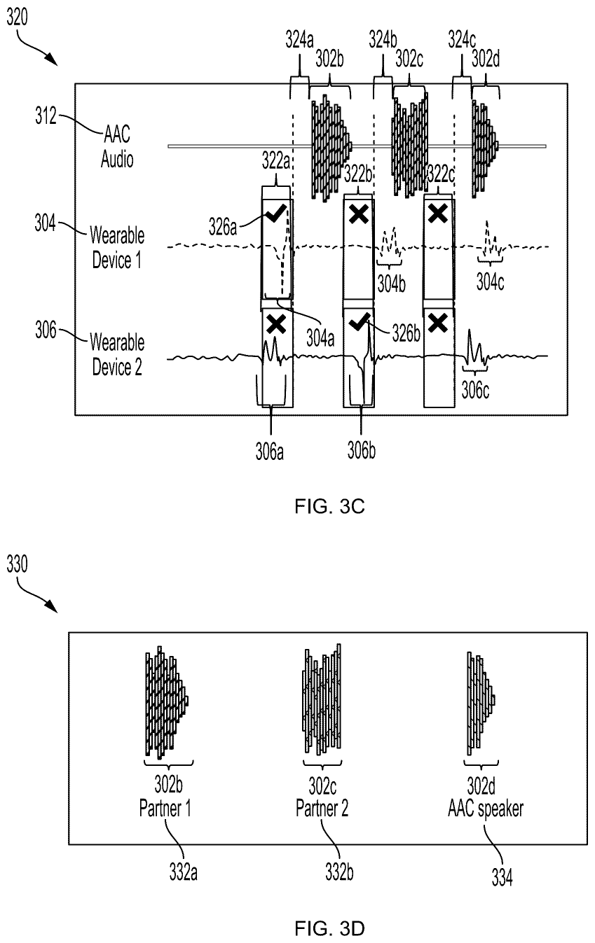

Turning to FIG. 3A, for example, a visualization of an example data set 300 includes a time series of motion signals 304, 306 from each wearable motion sensing device. As illustrated, each individual instance of motion 304a-c, 306a-c has a substantially similar duration. The motion signals 304, 306, for example, may have been pre-filtered, by the motion sensing wearable device and/or by the receiving computing device, to filter out motion signals not resembling a touch action.

Returning to FIG. 2A, in some implementations, if vocalizations are captured (210), the vocalizations are analyzed to identify all AAC audio portions (212). The vocalizations may be captured, for example, by one or more audio input devices of or connected to a computing device executing the method 200. A microphone of the mobile computing device 106 of FIG. 1, for example, may capture the vocalizations. As shown in FIG. 3A, for example, the vocalizations may include an ambient audio data set 302 including discrete vocalizations 302a-d. Each discrete vocalization 302a-d may include, in some examples, a start time (e.g., capture time) and a duration.

Analyzing the vocalizations, in a first example, may include applying a voice recognition algorithm to recognize a machine-generated voice versus a human voice. In another example, analyzing the vocalizations may include applying one or more filters to recognize a machine-generated voice versus a human voice. The analysis, in one example, may involve applying natural language processing (NLP) to recognize the utterance as a word or phrase used by an AAC device.

In some embodiments, the analyzing results in discarding one or more discrete vocalizations from the captured vocalizations, thereby producing an AAC audio data set. For example, as illustrated in an AAC audio data set 312 of an example refined data set 310 of FIG. 3B, a first vocalization 302a of the ambient audio data 302 of FIG. 3A has been discarded (e.g., as being a human vocalization).

Returning to FIG. 2A, in some implementations, if any AAC-generated vocalizations are identified (214), the begin time of the first AAC audio portion is used to analyze the sets of motion signals for correspondence (216). The AAC device, such as AAC device 102 of FIG. 1, may be designed to produce a vocalization responsive to a touch such that the vocalization should occur within a predetermined window of time of a touch event. Thus, any motion signals captured within a predetermined window of time prior to the begin time of the vocalization can be analyzed to determine if the vocalization could have been initiated by a wearer of a wearable motion sensing device. In certain instances, there may be no corresponding motion signals. For example, the wearable motion sensing device(s) may be asleep (e.g., in a sleep mode due to inaction by the wearer and/or any movement being below a signal magnitude threshold) within the relevant timeframe. In analyzing received motion signals in relation to times of AAC vocalizations, each AAC vocalization may be identified as having been produced due to a touch event associated with one of the wearable motion sensing devices or due to another touch (e.g., a touch event by the AAC speaker being trained to use the AAC device). The predetermined window of time, in illustration, may be within 50 milliseconds (ms), within 75 ms, or within 100 ms of the initiation of a touch event. The predetermined window of time, for example, may be based on a typical length of time for producing a touch event. Further, in some embodiments the predetermined window of time may include a lag, such that the vocalization occurs a set period of time after receipt of a touch event. For example, the predetermined window of time for a vocalization to occur after initiation of a touch event may be within 10-100 ms after initiation of a touch event, or 10 ms after termination of the touch event or registration of the touch event by the AAC device to match a delay between a touch event and the vocalization by the AAC device. Turning to FIG. 3C, for example, the predetermined window of time may include a time window 322a-c for a touch event (e.g., a length of time to press down and lift up) along with a time delay 324a-c after receipt of a touch event for a vocalization to be issued via the speaker of the AAC device. One or more software algorithms, machine learning models, and/or digital signal filters, in some examples, can be used to analyze the timing and length of touch events in view of the begin time of the AAC vocalization.

In reviewing a timing analysis diagram 320 of FIG. 3C, for example, a first time window 322a prior to a first time delay 324a is compared to both a duration of a first touch event 304a of the first set of touch data 304 corresponding to a first wearable motion sensing device and a duration of a first touch event 306a of the second set of touch data 306 corresponding to a second wearable motion sensing device. As is illustrated, both the first touch event 304a of the first set of touch data 304 and the first touch event 306a of the second set of touch data 306 align within the time window 322a. Thus, the first AAC audio vocalization 302b may have been triggered by a touch event performed by the wearer of the first wearable motion sensing device or by the wearer of the second motion sensing device. Turning a second time window 322b prior to a second time delay 324b, a second touch event 306b of the second set of touch data 306 aligns within the second time window 322b, while no touch event of the first set of touch data 304 lands within the second time window 322b. Thus, the second touch event 306b may have triggered the second AAC audio vocalization 302c. Finally, a third time delay 324c precedes a third AAC audio vocalization 302d. Prior to the third time delay 324c, a third time window 322c is positioned along the first set of touch data 304 and the second set of touch data 306 without overlapping with motion data associated with either of the wearable motion sensing devices. In this circumstance, the third AAC audio vocalization 302c is associated with a touch event by the AAC speaker (e.g., the AAC speaker 128 of FIG. 1).

Turning to FIG. 2B, if at least one of the sets of motion signals aligns with an AAC audio portion (218), in some implementations, it is determined whether the motion signals exhibit a touch pattern (220). The set of motion signals corresponding to a touch event at an AAC device, for example, may exhibit a general pattern style such that the set of touch signals can be analyzed (e.g., digitally filtered, provided to a machine learning model trained to recognize motion signal patterns corresponding to touch events, etc.) to classify each set of motion signals as either being a touch movement or a non-touch movement. For example, as illustrated in FIG. 3C, the motion signal pattern graph represented at the first time window 322a of the first set of touch data 304 illustrates a pattern indicative of a touch movement, as identified by the checkmark 326a, while the first time window 322a of the second set of touch data 306 is illustrated as having a very different (e.g., non-touch event) graphical pattern. In this manner, although the first touch event 306a of the second set of touch data 306 is temporally concurrent with the first touch event 304a of the first set of touch data 304, the method 200 is able to identify which wearable device was worn by the user that initiated the first AAC audio vocalization 302b.

In some implementations, if the analyzed motion signals were determined not to match a touch pattern (220), the method 200 repeats the analysis for all additional sets (222) of motion signals within the relevant timeframe. As described in relation to FIG. 3C, for example, both the first time window 322a of the first set of touch data 304 and the first time window 322a of the second set of touch data 306 would be analyzed.

In some implementations, when the motion signals are determined to exhibit a touch pattern (220), the AAC audio portion is correlated with input from the wearable device identifier corresponding to the set of motion signals (224). Turning to FIG. 3D, in illustration, a results data set 330 includes the first AAC vocalization 302b being correlated with a first communication partner 332a (e.g., correlated with a first wearable device identifier, such as the wearable device 108a of FIG. 1 which corresponds to the first communication partner 132a). Further, in the results data set 330, the second AAC vocalization 302c is correlated with a second communication partner 332b (e.g., correlated with a second wearable device identifier, such as the wearable device 108b of FIG. 1 which corresponds with the second communication partner 132b). The results data 330, for example, may be a visualization of at least a portion of the recognized AAC input data set 126 described in relation to FIG. 1.

Returning to FIG. 2B, if, instead, no set of motion signals aligns with a given AAC audio portion (222), the AAC audio portion is correlated with input from the AAC speaker (226). As illustrated in FIG. 3D, for example, the third AAC vocalization 302d is correlated with an AAC speaker 334.

In some implementations, for each additional AAC audio portion (228), the begin time of the next AAC audio portion is used to analyze sets of motion signals for correspondence (230).

Additionally, in some real-time or near real-time implementations, the method 200 may thus continue to receive and collect motion signals (206, 208), capture and analyze vocalizations (210, 212), and match touch events with a corresponding individual involved in the training session (226) throughout the training session.

Although described as a particular set of operations, in other embodiments, the method 200 may include more or fewer operations. For example, in some implementations, only those portions of the AAC audio corresponding to touch events by the AAC speaker are correlated and stored (226), while discarding any AAC audio events aligning with one of the wearable motion sensing devices. Additionally, although described in relation to a particular flow of operations, in other embodiments, certain operations of the method 200 may be performed in a different order and/or concurrently. For example, while for simplicity's sake the method 200 is laid out in a linear fashion, motion signals may be received (206) concurrently and/or intermittently with capturing vocalizations (210). In another example, the sets of motion signals may be filtered in advance of aligning (218) with the AAC audio portion to identify those sets of motion signals exhibiting a touch pattern (220). Other modifications to the method 200 are possible.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the method 200 of FIG. 2A and FIG. 2B.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the mobile computing device 106 and each of the wearable devices 108a, 108b of FIG. 1.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of content, in some examples, rendered to the display of the AAC device 102 and/or the mobile computing device 106 of FIG. 1.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. The databases may include one or more vector databases organized to store high-dimensional data points each mathematically representing the meaning and context of at least a portion of an original file (e.g., text document, audio file, rich media file, image file, photograph, video file, etc.). The vector database(s), for example, may incorporate a set of search algorithms for performing vector similarity searches such as, in some examples, an exhaustive k-nearest neighbors (KNN) algorithm, an approximate nearest neighbor (ANN) algorithm, a Locality Sensitive Hashing (LSH) algorithm, a Hierarchical Navigable Small World (HNSW), and/or an Inverted File Index (IVF) algorithm. The vector database(s), further, may include an embedded query engine for submitting a request to the vector database(s). Unlike traditional databases and query systems, for example, a vector database query may respond with a set of similar assets (e.g., objects or items) to the query information based on similarity metrics (e.g., as calculated by the set of search algorithms). The vector database(s), in some examples, may be implemented by Microsoft® Azure Cosmos DB or Cloudflare Vectorize by Cloudflare, Inc. of San Francisco, CA. For example, the contents of the storage medium 130 of FIG. 1 may be maintained in a database structure.

The systems described herein may communicate with the cloud computing environment through a secure gateway. In some implementations, the secure gateway includes a database querying interface, such as the Google BigQuery™ platform or Amazon RDS™.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as natural language processing operations and/or other audio analysis performed by the speech extraction unit 114 and/or the speech signal separation unit 116 of FIG. 1. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices disposed at a same general location as the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the method 200 of FIG. 2 may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the AAC device touches data set 122 and/or the AAC device speech data set 124 of FIG. 1. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

1. A system for evaluating training of an augmented and alternative communication (AAC) speaker by differentiating between AAC speaker inputs produced by an AAC speaker interacting with an AAC device and other training inputs to the AAC device during a training session, the system comprising:
a wearable device configured to be worn on a hand of a wearer, the wearable device comprising
at least one sensor configured to capture motion signals indicative of movements of the hand of the wearer, and
communication circuitry configured to share the motion signals; and
at least one non-transitory computer-readable medium comprising program instructions that, when executed by at least one processor, cause the at least one processor to
receive, from the wearable device, a set of motion signals,
capture audio data comprising
at least one vocalization, and
time data representing capture of each vocalization of the at least one vocalization, and
identify a source of one or more AAC inputs to the AAC device entered within a timeframe of the audio data by, for each respective vocalization of the at least one vocalization,
determining whether the respective vocalization is audio output generated by the AAC device in response to a respective AAC input of the one or more AAC inputs,
in response to determining the respective vocalization is the audio output, analyzing the set of motion signals for a respective portion of motion signals corresponding with a timeframe of the respective vocalization, wherein to analyze comprises
in response to failing to identify any of the set of motion signals corresponds with the timeframe of the respective vocalization, identifying the AAC speaker as the source of the respective AAC input, and
in response to identifying the respective portion of motion signals corresponds with the timeframe, determining whether the respective portion of the motion signals exhibits a touch pattern, wherein
in response to determining the respective portion of the signals fails to exhibit the touch pattern, the AAC speaker is identified as the source of the respective AAC input.

2. The system of claim 1, wherein the program instructions further cause the at least one processor to, responsive to identifying the AAC speaker as the source of the respective AAC input, store a correlation between the AAC speaker and a portion of the audio data corresponding with the respective vocalization.

3. The system of claim 1, wherein determining the respective vocalization is the audio output comprises filtering the audio data to recognize machine-generated vocalizations.

4. The system of claim 1, wherein a handheld computing device comprises the at least one processor.

5. The system of claim 4, wherein capturing the audio data comprises capturing, by a microphone of the handheld computing device, the audio data.

6. The system of claim 4, wherein:
the communication circuitry of the handheld computing device is configured for wireless communication; and
receiving the set of motion signals comprises receiving, via wireless communication circuitry of the handheld computing device, the set of motion signals.

7. The system of claim 1, wherein the wearable device is a finger ring.

8. The system of claim 1, wherein receiving the set of motion signals, capturing the audio data, and identifying the source of the one or more AAC inputs are performed repeatedly during the training session.

9. The system of claim 1, wherein to determine the portion of the motion signals exhibits a touch pattern comprises filtering the motion signals to remove motion signals dissimilar from press motions.

10. The system of claim 1, wherein the program instructions further cause the at least one processor to, prior to receiving the motion signals, recognize, via a communication from the communication circuitry of the wearable device, an identifier of the wearable device.

11. The system of claim 10, wherein the program instructions further cause the at least one processor to:
recognize a second identifier of a second wearable device; and
receive, from the second wearable device, a second set of motion signals,
wherein to identify the source of the one or more AAC inputs comprises
analyzing the second set of motion signals for a respective portion of second motion signals corresponding with the timeframe of the respective vocalization, wherein the AAC speaker is identified as the source of the respective AAC input either
a) further in response to failing to identify any of the second set of motion signals corresponds with the timeframe of the respective vocalization, or
b) further in response to determining a portion of the second set of motion signals corresponding with the timeframe fails to exhibit a second touch pattern.

12. A method for evaluating training of an augmented and alternative communication (AAC) speaker by differentiating between AAC speaker touch events produced by an AAC speaker interacting with an AAC device and other training touch events to the AAC device during a training session, the method comprising:
recognizing, by processing circuitry, at least one wearable motion sensing device;
during an AAC training session, capturing, by the processing circuitry, audio data;
receiving, from the at least one wearable motion sensing device via communication circuitry, gesture data comprising sets of motion signals sensed by the at least one wearable motion sensing device during the training session;
analyzing, by the processing circuitry, the audio data to identify a plurality of AAC audio portions corresponding to output of the AAC device; and
for each respective AAC audio portion of the plurality of AAC audio portions of the audio data,
analyzing, by the processing circuitry, the gesture data in view of a begin time of the respective AAC audio portion to identify correspondence between a respective motion data set of the sets of motion signals and the begin time,
responsive to identifying correspondence, analyzing, by the processing circuitry, the respective motion data set to identify a touch pattern, and
responsive to identifying either a) lack of correspondence between the respective motion data set and the begin time or b) lack of the touch pattern, correlating, by the processing circuitry, the respective AAC audio portion with the AAC speaker.

13. The method of claim 12, wherein analyzing the gesture data in view of the begin time comprises analyzing the respective motion data set comprising motion signals captured within a predetermined window of time prior to the begin time.

14. The method of claim 12, further comprising, responsive to identifying the touch pattern, correlating, by the processing circuitry, the respective AAC audio portion with a wearer of the wearable motion sensing device.

15. The method of claim 12, wherein identifying the plurality of AAC audio portions comprises filtering the audio data to separate speech audio bandwidth from other audio bandwidth.

16. The method of claim 12, wherein identifying the touch pattern comprises applying the respective motion data set to a machine learning model trained to classify motion signals as one of a touch movement or a non-touch movement.

17. The method of claim 12, wherein correlating the respective AAC audio portion with the AAC speaker comprises storing the respective audio portion and the begin time to a non-transitory computer readable-medium.

18. The method of claim 12, wherein capturing the audio data comprises capturing, by a microphone of a computing device comprising the processing circuitry, the audio data.

19. The method of claim 12, wherein the gesture data is received during the training session.

20. The method of claim 12, wherein recognizing the at least one wearable motion sensing device comprises performing, with each wearable motion sensing device of the at least one wearable motion sensing device, a wireless communications handshaking mechanism.
